(19) United States
(12) Patent Application Publication
(10) Pub. No.: US 2010/0185879 A1
(43) Pub. Date: Jul. 22, 2010

(54) LOAD BALANCING POWER SUPPLIES

(76) Inventor: Charles N. Shaver, Cypress, TX (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/357,642

(22) Filed: Jan. 22, 2009

(51) Int. Cl. G06F 1/00

(52) U.S. Cl. 713/300

(57) ABSTRACT

In one embodiment, a computer system comprises an enclosure, at least one power supply module in the enclosure, the power supply comprising at least a first power output and a second power output, at least one compute node, comprising an input/output module and logic to generate a power input signal to indicate a power input, and at least one administrative module coupled to the at least one power supply module and the at least one compute node. The administrative module comprises an input/output module, a power supply selector circuit module comprising logic to detect the power input signal generated by the at least one compute node and couple the compute node to one of the first power output or the second power output based at least in part on the power input signal.

### BACKGROUND

Blade personal computers (PCs) and servers represent a fast growing segment in the computing industry because of the compaction, consolidation, modularity, management, and maintenance afforded by the blade PCs and servers. The growth in the use of blade PCs and servers has led to challenges in efficiently powering blade servers.

### BRIEF DESCRIPTION OF THE DRAWINGS

FIGS. 1A-1B are schematic illustrations of computing environments according to embodiments.

FIG. 2 is a schematic illustration of a administrative module, according to an embodiment.

FIG. 3 is a schematic illustration of a compute node according to an embodiment.

FIG. 4 is a flowchart illustrating operations in a method to measure power consumption according to an embodiment.

FIG. 5 is a schematic illustration of a power supply selector circuit module, according to embodiments.

FIG. 6 is a flowchart illustrating operations in a method to measure power consumption according to an embodiment.

### DETAILED DESCRIPTION

Described herein are exemplary system and methods for load balancing power supplies in computing environments such as blade servers or blade PCs. In some embodiments, the methods described herein may be embodied as logic instructions on a computer-readable medium. When executed on a processor, the logic instructions cause a general purpose computing device to be programmed as a special-purpose machine that implements the described methods. The processor, when configured by the logic instructions to execute the methods recited herein, constitutes structure for performing the described methods. In alternate embodiments the methods described herein may be implemented in firmware, in a reprogrammable logic module, e.g., a field programmable gate array, or hardwired into electrical circuitry.

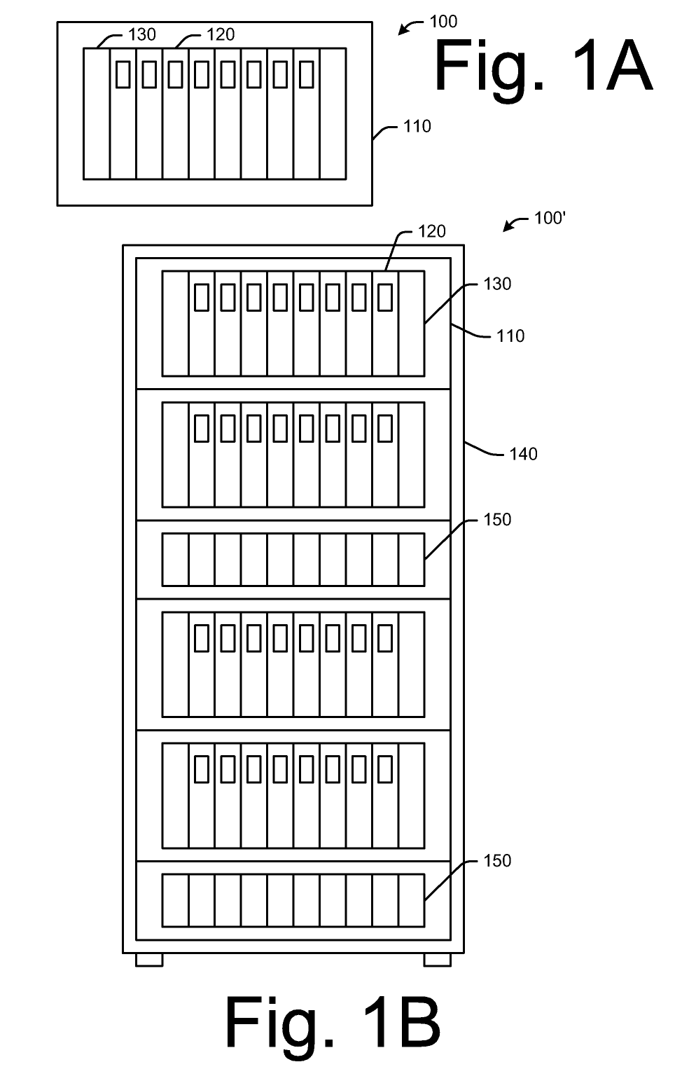

FIGS. 1A-1B are schematic illustrations of computing environments in which methods for load balancing power supplies may be implemented, according to embodiments. With reference first to FIG. 1A, there is shown a simplified frontal view of an computing environment 100 in which various embodiments of the invention may be practiced. The computing environment 100 depicted in FIG. 1A generally comprises an enclosure 110 housing a number of compute nodes 120, such as, computer systems, servers, memories, hard drives, etc. In FIG. 1A, however, the compute nodes 120 are depicted as comprising blade PCs and servers arranged in horizontal alignment with respect to each other in the enclosure 110. The compute nodes 120 are also depicted as including various components generally known to form part of conventional electronic systems, such as, various connectors, buttons, indicators, etc.

In addition to the compute nodes 120, the enclosure 110 may include other components, such as, interconnects 130. The interconnects 130 generally operate to route network signals to and from the compute nodes 120. Two interconnects 130 may be provided to provide redundancy for the compute nodes 120.

Although eight compute nodes 120 and two interconnects 130 have been illustrated as being contained in the enclosure 110, any reasonably suitable number of compute nodes 120 and interconnects 130 may be included in the enclosure without departing from a scope of the invention. In addition, the computing environment 100 may include additional components and some of the components depicted may be removed and/or modified without departing from a scope of the computing environment 100.

It should also be understood that various embodiments of the invention may be practiced in computing environments having different configurations than the computing environment 100 depicted in FIG. 1A. By way of example, various embodiments of the invention may be practiced in computing environments having different types of compute nodes 120, for instance, in computing environments having horizontally arranged servers. In addition, or alternatively, various embodiments of the invention may be practiced in a larger scale computing environment in comparison with the computing environment 100 depicted in FIG. 1A.

An example of a larger scale computing environment 100′ is depicted in FIG. 1B. More particularly, FIG. 1B illustrates a simplified frontal view of a rack 140, such as, an electronics cabinet, housing four enclosures 110. The rack 140 is also depicted as including two sets of power supplies 150. The rack 140 may, however, house any reasonably suitable number of enclosures 110, such as, six, eight, or more, as well as any reasonably suitable number of power supplies 150. In addition, the enclosures 110 included in the rack 140 may also house any reasonably suitable number of compute nodes 120.

Various embodiments of the invention may further be practiced in computing environments containing a relatively larger number of compute nodes 120 than are depicted in FIG. 1B. For instance, various embodiments of the invention may be practiced amongst compute nodes contained in a data center or compute nodes positioned at different geographic locations with respect to each other. The different geographic locations may include, for instance, different rooms, different buildings, different counties, different countries, etc.

In some embodiments, computing environment 100′ may include one or more administrative modules 160 which, among other things, implement operations to facilitate load balancing for the one or more power supplies 150 in system 150. In some embodiments, power supplies 150 comprise multiple power outputs, i.e., at least a first power output and a second power output, which provide power to the devices in the computing environment. The power outputs may have the same voltage, or may have different voltages.

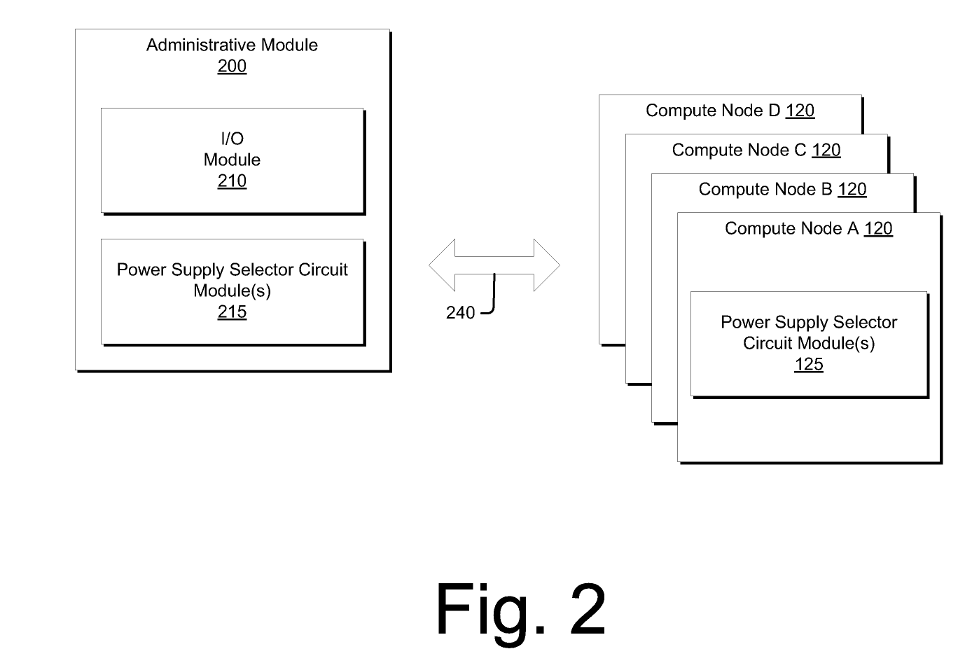

With reference now to FIG. 2, there is shown a block diagram of an administrative module 200 and a plurality of compute nodes 120 according to various embodiments. In embodiments, at least one of the administrative module 200 or the compute nodes 120 comprise a power supply selector circuit module, which implements logic to select a power supply circuit for one or more compute nodes. The following description makes specific reference to the elements depicted in the computing environments 100, 100′. It should, however, be understood that the administrative module 200 may be implemented in environments that differ from those environments 100, 100′ depicted in FIGS. 1A and 1B, as described above.

As shown in FIG. 2, the administrative module 200 includes an input/output module 210 and one or more power supply selector circuit modules 215. Input/output module 210 provides a communication interface with one or more components of computing environment 100′, e.g., with one or more compute nodes 120. Power supply selector circuit module 215 implements logic to select a power supply to which a component such as one or more compute nodes 120 may be connected. As depicted in FIG. 2, alternately, or in addition, one or more compute nodes 120 may comprise a power supply selector circuit module 125.

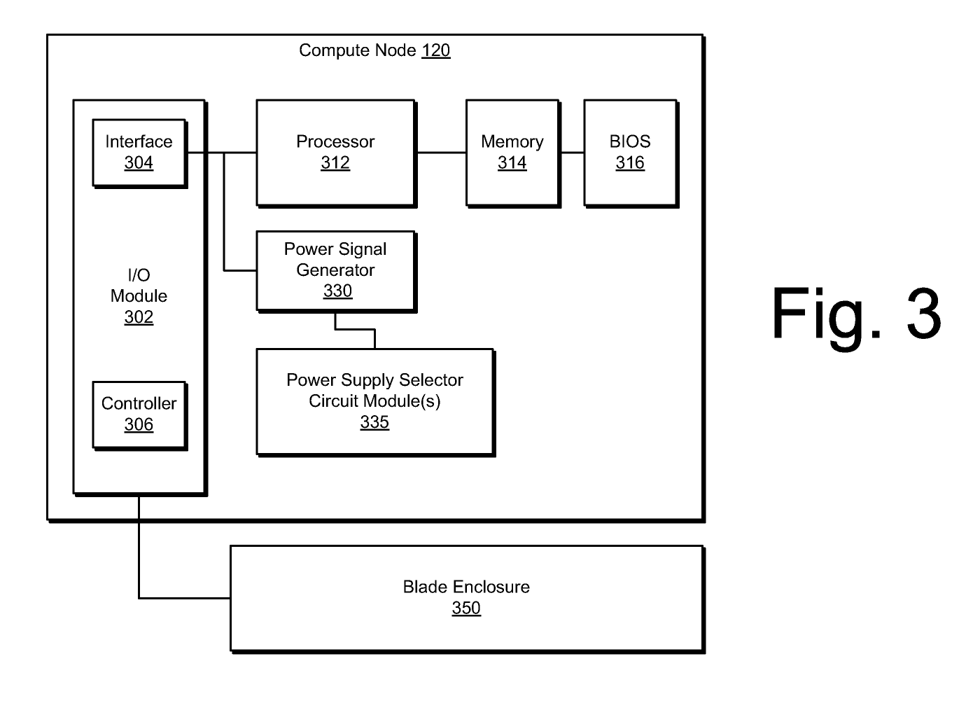

FIG. 3 is a schematic illustration of a compute node 120 according to an embodiment. In one embodiment, the compute node 120 may correspond to one of the compute nodes 120 depicted in FIGS. 1A, 1B, and 2. Referring briefly to FIG. 3, compute node 120 may include an input/output (I/O) module 302 to manage I/O operations between components of compute node 120 and between compute node 120 and other devices, such as administrative module 200, in blade enclosure 350. In one embodiment, I/O module 302 may be implemented as an integrated circuit (IC) that includes one or more interfaces 304 through which I/O operations may be managed and a controller 306 to manage the operations of I/O module 302.

Compute node 120 may further include a processor 312, a memory module 314, and a basic input/output system (BIOS) 316. Processor 312 may be embodied as a central processing unit (CPU). In one embodiment, processor 312 may be configurable to operate at one of multiple power states, which permits the compute node 120 to be manageable with regard to power consumption. In one embodiment, processor 312 may be implemented as an Athlon 64 processor commercially available from AMD Corporation of Sunnyvale, Calif., USA. Memory module 318 may be implemented as a suitable volatile memory such as, e.g., random access memory (RAM) memory.

In one embodiment, BIOS 316 may be incorporated in a non-volatile memory module, which may be embodied as a flash random Read Only Memory (ROM). The BIOS may comprise code that provides an interface between the operating system and the specific hardware configuration, allowing the same operating system to be used with different hardware configurations. In one embodiment, BIOS 316 may comprise a power-on self-test (POST) module for performing system initialization and tests. In operation, when activation of compute node 120 begins processor 312 accesses BIOS 316 and shadows the instructions of BIOS 316, such as power-on self-test module, into operating memory. Processor 312 then executes power-on self-test operations to implement POST processing.

Compute node 120 may further include one or more power signal generator modules 330. In some embodiments, power signal generator module 330 implements logic to generate a power input signal which indicates one or more characteristics of a power supply to which the compute node 120 may be connected. In some embodiments, the power input signal generated by the power signal generator 330 is transmitted to the power supply selector circuit 215 of the administrative module 215, which selects a power output to connect the compute node 120 to in response to the power input signal. Thus, in some embodiments the power supply selector circuit module 215 cooperates with the power signal generator 330 to select a power supply for the compute node 330. In some embodiments, the power supply selector circuit module(s) 325 on the compute node 120 selects a power output to connect the compute node 120 to in response to the power input signal generated by the power signal generator 330.

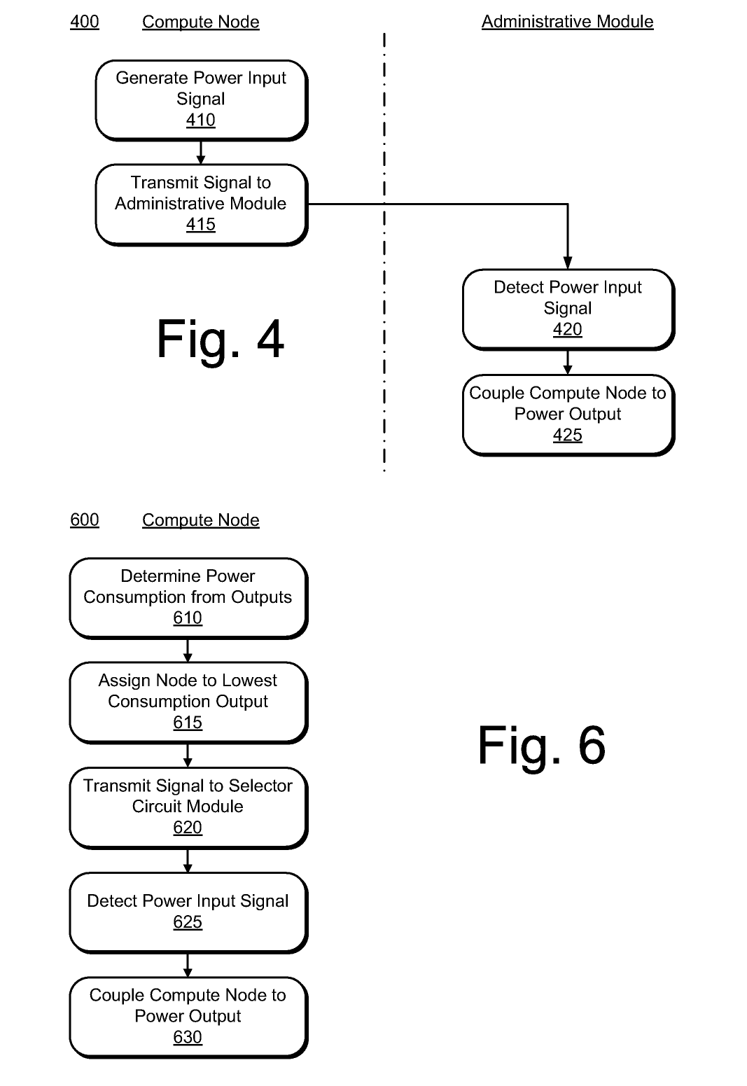

FIG. 4 is a flowchart illustrating operations 400 in a method to load balance power supplies according to an embodiment. In one embodiment the operations of FIG. 4 may be implemented as logic implemented by a compute node 120 and an administrative module 200 in a computer system 100. Referring to FIG. 4, at operation 410 a compute node 120 generates a power input signal. In one embodiment, the power input signal may be generated by processor 312 in response to an operating condition or environment. In some embodiments the power input signal may be generated by detecting the slot number into which the compute node 120 is connected. For example, compute nodes coupled to an even-numbered slot may generate a power input signal indicating that the compute node should be connected to a first power output while compute nodes connected to an odd-numbered slot may generate a power input signal indicating that the compute node should be connected to a second power output. Alternatively, compute nodes connected to a first range of slots (i.e., slots 1-10) may generate a power input signal indicating that the compute node should be connected to a first power output while compute nodes connected to a second range of slots (i.e., slots 11-20) may generate a power input signal indicating that the compute node should be connected to a second power output. Alternate mechanisms to generate a power input signal may also be practiced.

At operation 415 the power input signal is transmitted to the administrative module 200. In some embodiments, the power input signal is transmitted via the I/O module 402 of compute node 120 to the I/O module 210 of administrative module 200.

At operation 420 the administrative module detects the power input signal generated by compute node 120, and at operation 425 the administrative module 200 couples the compute node to a power output based at least in part on the power input signal received from the compute node 120. For example, in some embodiments the power input signal specifies a voltage level, and the administrative module 210 couples the compute node to a power output having the specified voltage level.

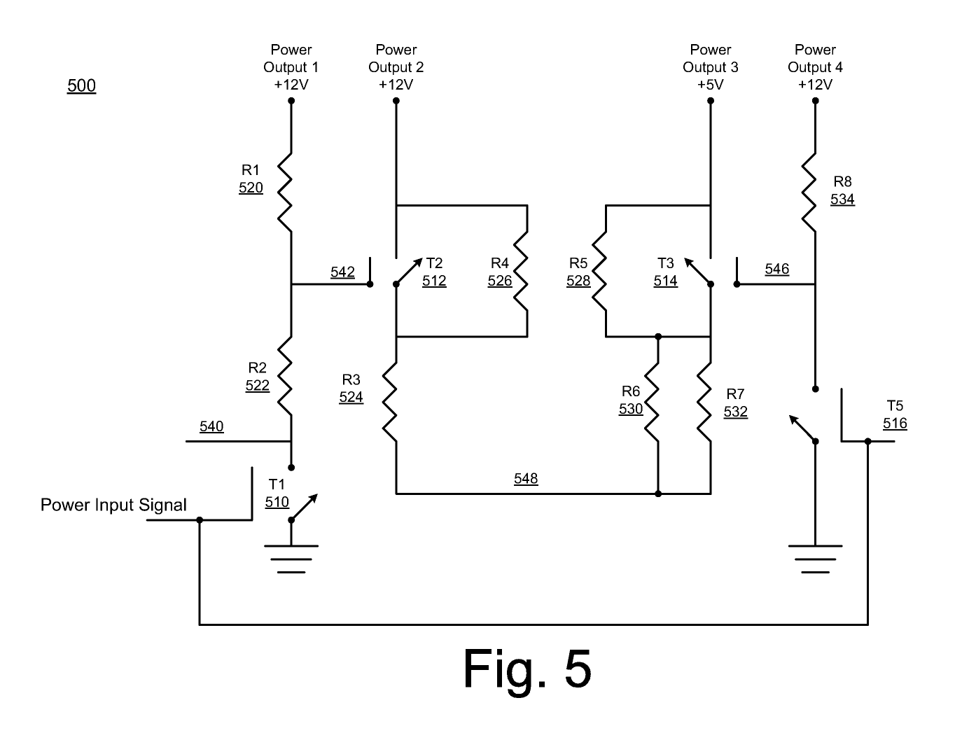

In some embodiments the administrative module 210 comprises a power supply selector circuit 215 which couples the compute node 120 to a power output based on a value of the power input signal. FIG. 5 is a schematic illustration of a power supply selector circuit module 215, according to embodiments. Referring to FIG. 5, transistors T2 512 and T3 514 are dual N and P channel FETs, each of which includes one N-channel and one P-channel FET. Transistors T1 510 and T5 516 are N-channel FETs which can be used to switch signals between high and low.

The P-channel sides of T2 512 and T3 514 are connected to 12V and the N-channel sides of T2 512 and T3 514 are connected to 5V. FET transistors T2 512 and T3 514 each have three terminals: a gate, a source, and a drain. The voltage between the gate and source turns on or off the FET. A P-channel FET will turn on when the gate is lower than the source and an N-channel FET will turn on when the gate is higher than the source terminal of the FET.

In operation, the Power Input Signal is input to transistors T1 510 and T5 516 to select whether to use 12V or 5V as the output signal of the selector circuit. When the Power Input Signal is high this connects the drain and source of T1510 and T5 516 to GROUND, which in turn connects lines 540 and 542 to GROUND. Resistors R1 520 and R2 522 form a voltage divider that will set the gate voltage of transistor T2 512 to 8V (assuming line 542 is at 8V when R2 522 is connected to GROUND). When line 542 is set to 8V the gate-source voltage (Vgs) of transistor T2 512 is set to −4V, which turns on transistor T2 512 and selects +12V_DB as the output of the selector circuit. With T5 516 and line 546 connected to GND, the gate of T3 514 is connected to GROUND, which is equivalent to 0 volts. This makes the Vgs of T3 514 0 volts, which turns off T3 514. Thus, when the Power Input Signal high, 12V is selected as the output voltage from the selector circuit.

By contrast, when the power input signal is set low level, the Vgs of T1 510 and T5 516 is now 0 volts, which this turns off T1 510 and T5 516. Transistors T1 510 and T5 516 being off can be modeled as an open circuit.

With T1 510 off, R2 522 has no ability to conduct current and is not a part of the circuit. Resistor R520 connects 12V to the gate of T2 512 and sets line 542 to 12V. With the gate of T2 512 set to 12V through R522 and the source connected to 12V, the Vgs of T2 512 is 0V (12−12=0) and T2 is turned off.

With T5 516 off because the Power Input Signal is low, R8 534 connects to the gate of T3 514 and sets line 546 to 5V, which in turn sets the gate of T3 514 to 12V. The source of T3 514 is connected to resistor R8 534 and R7 532 and initially has no voltage when line 546 is set to 12V. The Vgs of transistor T3 514 will briefly be close to 12V which will turn on transistor T3 514 and allow the 5V voltage to be placed on the source, which will set Vgs of transistor T3 514 to 7V (12V−5V=7V), which is sufficient to turn on T3 514 so that 5V is output on to line 548.

In some embodiments, administrative module 200 comprises a plurality of power supply selector circuit modules 215, while in alternate embodiments the administrative module may comprise a single power supply selector circuit module 215 and signals from the compute nodes 120 may be multiplexed into the single circuit. In still other embodiments the power supply selector circuit module 215 may be located in the compute nodes 120.

In some embodiments the compute node 120 plays a more active load balancing role in determining the power output to which the compute node is to be elected. FIG. 6 is a flowchart illustrating operations 600 in a method to load balance power supplies according to such an embodiment. Referring to FIG. 6, at operation 610 the power signal generator module 330 in the compute node 120 determines the power consumption from one or more power outputs in a power supply 150 of the computer system. At operation 615 the signal generator module 330 assigns the compute node to the power output having the lowest power consumption. At operation 620 the signal generator module 330 transmits the power input signal to the power supply selector circuit module 335. At operation 625 the power supply selector circuit module 335 detects the power input signal generated by compute node 120, and at operation 630 the power supply selector circuit module 335 couples the compute node to a power output identified in the power input signal received from the compute node 120.

Thus, described herein are numerous techniques to load balance power supplies in computing systems such as blade server systems. Embodiments described herein may be provided as computer program products, which may include a machine-readable or computer-readable medium having stored thereon instructions used to program a computer (or other electronic devices) to perform a process discussed herein. The machine-readable medium may include, but is not limited to, floppy diskettes, hard disk, optical disks, CD-ROMs, and magneto-optical disks, ROMs, RAMs, erasable programmable ROMs (EPROMs), electrically EPROMs (EEPROMs), magnetic or optical cards, flash memory, or other suitable types of media or computer-readable media suitable for storing electronic instructions and/or data. Moreover, data discussed herein may be stored in a single database, multiple databases, or otherwise in select forms (such as in a table).

Reference in the specification to “one embodiment” or “an embodiment” means that a particular feature, structure, or characteristic described in connection with the embodiment is included in at least an implementation. The appearances of the phrase “in one embodiment” in various places in the specification are not necessarily all referring to the same embodiment.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A computer system, comprising:
an enclosure;
at least one power supply module in the enclosure, the power supply module comprising at least a first power output and a second power output;
at least one compute node, comprising:
an input/output module; and
logic to generate a power input signal to indicate a power input; and
at least one administrative module coupled to the at least one power supply module and the at least one compute node, the administrative module comprising:
an input/output module;
a power supply selector circuit module comprising logic to:
detect the power input signal generated by the at least one compute node; and
couple the compute node to one of the first power output or the second power output based at least in part on the power input signal.

2. The computer system of claim 1, wherein the first power output provides power at a first voltage and the second power output provides power at a second voltage, different from the first voltage.

3. The computer system of claim 1, wherein the logic to generate a power input signal comprises logic to generate a power input signal based at least in part on a slot number in the enclosure to which the compute node is coupled.

4. The computer system of claim 3, wherein the power supply selector circuit comprises:
a power connection to the at least one computer node; and
an input to receive the power input signal from the at least one compute node, wherein the input is coupled to the first power output by a first transistor having a first threshold value, such that the power connection to the at least one compute node is coupled to the first power output when the power input signal is less than the first threshold value.

5. The computer system of claim 4, wherein the input is coupled to the second power output by a second transistor having a second threshold value, such that the power connection to the at least one compute node is coupled to the second power output when the power input signal is greater than the second threshold value.

6. A method in a computer system to select a power output of a power supply comprising at least a first power output and a second power output;
generating, in a compute node of the computer system, a power input signal to indicate a power input; and
detecting, in a power supply selector circuit, the power input signal generated by the at least one compute node; and
coupling the compute node to one of the first power output or the second power output based at least in part on the power input signal.

7. The method of claim 6, wherein the first power output provides power at a first voltage and the second power output provides power at a second voltage, different from the first voltage.

8. The method of claim 6, wherein generating a power input signal comprises generating a power input signal based at least in part on a slot number in the enclosure to which the compute node is coupled.

9. The method of claim 6, wherein coupling the compute node to one of the first power output or the second power output comprises:
receiving the power input signal from the at least one compute node, wherein the input is coupled to the first power output by a first transistor having a first threshold value, such that the power connection to the at least one compute node is coupled to the first power output when the power input signal is less than the first threshold value.

10. The computer system of claim 9, wherein the input is coupled to the second power output by a second transistor having a second threshold value, such that the power connection to the at least one compute node is coupled to the second power output when the power input signal is greater than the second threshold value.

11. A computer system, comprising:
an enclosure;
at least one power supply module in the enclosure, the power supply module comprising at least a first power output and a second power output;
at least one compute node, comprising:
a power input; and
a power supply selector circuit module comprising logic to:
determine a power consumption value from the first power output and the second power output; and
couple the compute node to one of the first power output or the second power output based at least in part on the power consumption value.

12. The computer system of claim 11, wherein the first power output provides power at a first voltage and the second power output provides power at a second voltage, different from the first voltage.

13. The computer system of claim 11, wherein the logic to determine a power consumption value from the first power output and the second power output comprises logic to actively monitor the power consumption drawn from the first power output and the second power output.

14. The computer system of claim 13, wherein the logic to determine a power consumption value from the first power output and the second power output comprises logic to:
compare the power consumption drawn from the first power output and the second power output; and
couple the compute node the power output having the lowest power consumption.

15. A method in a computer system to select a power output of a power supply comprising at least a first power output and a second power output, comprising:
determining, in a power supply selector circuit, a power consumption value from the first power output and the second power output; and
couple the compute node to one of the first power output or the second power output based at least in part on the power consumption value.

16. The method of claim 15, wherein the first power output provides power at a first voltage and the second power output provides power at a second voltage, different from the first voltage.

17. The method of claim 15, determining a power consumption value from the first power output and the second power output comprises actively monitoring the power consumption drawn from the first power output and the second power output.

18. The method of claim 15, wherein determining a power consumption value from the first power output and the second power output comprises:
comparing the power consumption drawn from the first power output and the second power output; and
coupling the compute node the power output having the lowest power consumption.
